(19) United States
(12) Patent Application Publication
(10) Pub. No.: US 2011/0287225 A1
(43) Pub. Date: Nov. 24, 2011

(54) HIGH PERFORMANCE CONNECTORS

(75) Inventor: Anthony Decarmine, Lebanon, CT (US)

(73) Assignee: ARKEMA INC., King of Prussia, PA (US)

(21) Appl. No.: 13/145,421

(22) PCT Filed: Jan. 15, 2010
(86) PCT No.: PCT/US10/21102

§ 371 Date: Jul. 20, 2011

Related U.S. Application Data
(60) Provisional application No. 61/145,845, filed on Jan. 20, 2009.

(51) Int. Cl. B32B 3/00

(52) U.S. Cl. 428/156

(57) ABSTRACT

High performance connectors, such as electrical connectors intended for use in circuit boards that are to be subjected to reflow soldering or rework or fiber optic connectors to be employed in harsh operating conditions, are manufactured using polymeric compositions containing polyetherketoneketone and mineral nanotubes. These polymeric compositions provide connectors having exceptional dimensional stability at high temperatures and facilitate the precise and high quality molding of connectors with thin or finely detailed features.

### FIELD OF THE INVENTION

The invention relates to connectors for use in applications and assemblies requiring exposure to elevated temperatures, wherein the connectors support one or more conductive members such as electrically conductive members, optic fibers, or pipes or lines carrying gases or liquids. In particular, the invention pertains to connectors having main bodies comprised of polymeric compositions that are capable of withstanding repeated exposure to high temperatures with minimal distortion or warping, such as when a circuit board is subjected to reflow soldering or rework operations.

### DISCUSSION OF THE RELATED ART

Connectors are frequently utilized to join together individual components in a way that permits those components to transmit electricity, light, gases, liquids or the like to each other.

For example, electrical connectors are used to place electrical devices, such as printed circuit boards, in communication with one another. An electrical connector typically has two portions, one portion of which connects to a first electrical device and the second portion of which connects to a second electrical device to be put into communication with the first device. To connect the two devices, the two portions of the electrical connector are mated together.

Each portion of the connector includes one set of contacts or terminals adapted to communicatively couple to an electronic device and a second set of contacts or terminals adapted to matingly couple to the other connector portion. This can be readily accomplished by designating one portion of the connector as having “male” contacts or terminals adapted to couple to the other connector portion's “female” contacts or terminals. Regardless of the specifics of the design of the contacts or terminals, the two connector portions should be adapted to be easily connected and disconnected from each other to respectively electrically link and unlink the electrical devices to which they are connected.

Accordingly, each connector portion is fixedly connected to an electronic device through its remaining set of contacts or terminals. The contacts or terminals may be removably or permanently connectable to the electrical device; however, it is often desired that the connector portion be secured to the electrical device through some physical mechanism. Typically, the connector portions are secured to electrical devices by soldering or otherwise fusing the contacts or terminals to contact pads or the like formed on the electrical device.

There are a number of applications where an electrical connector will be exposed to elevated temperatures, such as during fabrication of an assembly that includes the electrical connector, the repair or modification of such an assembly, and/or the use or operation of such an assembly. The electrical connector typically must be capable of maintaining dimensional stability and mechanical strength under such conditions without exhibiting an unacceptable degree of warping, distortion or cracking.

In recent years, there has been an increasing trend towards the use of reflow techniques to secure electrical connectors to electronic devices such as printed circuit boards. For example, portions of solder (which may be in the form of a solder paste that also contains flux) may be placed on the contacts of an electrical connector and/or on the contact pads of the printed circuit board. The solder portions may be in the form of balls, for example. The electrical connector contacts are then positioned against the contact pads with the solder portions therebetween and the assembly (or a localized section thereof) is then heated to a temperature effective to melt the solder portions, causing them to reflow. Upon cooling the assembly, the solder portions solidify, thereby establishing electrical connections between the electrical connector contacts and the printed circuit board contact pads. Similarly, pin in hole intrusive reflow assembly techniques have been developed wherein a solder paste is stencil printed onto the surface of a printed circuit board having through hole pads such that the solder paste penetrates into the through holes. Pins on an electrical connectors are thereafter inserted into the holes and the resulting assembly heated to reflow the solder.

There has also recently been increased interest in using lead-free solders in such applications, due to the toxicity and environmental issues associated with traditional lead-containing solders. However, lead-free solders typically require the use of significantly higher processing temperatures, such as during initial assembly, reflow, rework and wave soldering. As electric connectors generally are fabricated using plastic bodies to retain or support the metallic conductor members that are employed to electrically connect individual electric devices, working with lead-free solders is very challenging clue to the tendency of plastics (even high performance engineering plastics) to distort, warp or even crack under the conditions necessary to achieve satisfactory flow or reflow of the lead-free solder. Such distortion, cracking or warping interferes with the ability to properly align the individual electrical connector contacts with the corresponding printed circuit board contact pads such that the desired electrical connections between these components are established and maintained. This problem is especially acute when pin-in-hole reflow (PIHR) methods are utilized wherein an array of pins on a connector is to be inserted into an array of through-holes on a circuit board. Ideally, the size of the through-hole is only 0.010 to 0.015 inches larger than the maximum diameter of the connector pin that is to be inserted into the through-hole and electrically connected by reflow soldering. These tight tolerances require very precise alignment of the arrays of pins and through-holes. If the main body supporting the pins warps even slightly due to heat distortion, this alignment may be very difficult to maintain, especially where the pin array contains a large number of pins and/or where the main body is relatively long and/or wide and is relatively thin.

Additionally, once the solder interconnections are completed, the components may need to be detached from one another. Electronics fabrication processes often require disassembly of assembled components, for example, to carry out diagnostic tests, to replace or repair one or more components, to upgrade components, or to recover electrically good substrates from test vehicles or early user hardware used to assess product performance and reliability prior to actual product release.

Current approaches for removing electrical components from circuit boards include removal by hot gas. In such hot gas methods, a stream of heated gas, such as nitrogen or another inert gas, is delivered onto or directed at the electrical component attached to the board via a nozzle. Additional bias heat may be applied via a heating block or heating unit located at the backside of the board to supplement the other thermal inputs. The heat generated at the solder interconnections joining the electrical component to the board liquefies the solder joints allowing such electrical component to be removed from the circuit board for rework. Since it is difficult to control the heating such that only the desired solder interconnections are exposed to high temperatures, it is critical that any plastic or resin portions of the electrical component be dimensionally stable when heated (i.e., capable of withstanding the high temperatures encountered during rework without exhibiting an unacceptable degree of warping, distortion or cracking).

Where the solder interconnections are lead-free solder interconnects, these interconnection schemes generally require the use of significantly higher temperatures for rework processing than is necessary when traditional lead-containing solders are utilized. The higher rework temperatures for near eutectic and eutectic lead free solder alloys (Sn/Ag, Sn/Ag/Cu, Sn/Cu), typically range from about 217 degrees C. to about 227 degrees C., and may be higher for hyper-eutectic compositions of the foregoing alloys, such as at temperatures above 227 degrees C. or greater. To reproducibly achieve high quality electrical connectors, it is common to use rework temperatures of 250 degrees C. or 260 degrees C. or higher. These higher rework temperatures for lead-free solders can irreparably damage the thermoplastics conventionally used to fabricate the main bodies of electrical connectors. The high performance thermoplastic materials such as polyetheretherketones (PEEK), liquid crystal polymers (LCP), and polyphenylene sulfides (PPS) currently used in such electrical connectors have failed to demonstrate the required thermal and mechanical stability necessary to avoid warping and cracking when an assembly including a circuit board and the connector is manufactured using reflow or rework soldering techniques.

Connectors are also frequently used to join together different sections of an optical fiber, as the connector enables quicker connection and disconnection than splicing. The connectors mechanically couple and align the cores of fibers so that light can be passed from one section of fiber to another. The fiber end-faces must be held or pressed together in a very precise manner such that alignment and direct contact of the fiber ends (glass to glass or plastic to plastic, for example) are achieved, avoiding any glass to air or plastic to air interfaces, which would result in higher connector losses. It is critical that this tight alignment and contact be maintained not just when the connection is initially made, but also over the life of the fiber optic cable. Typically, a fiber optic connector contains a ferrule, which is a long, thin cylinder which acts as a fiber alignment mechanism. The ferrule has a center bore within which the optic fiber is held, with the end of the fiber located at the end of the ferrule. A connector body (sometimes referred to as a connector housing), which may include one or more assembled pieces, generally is used to hold the ferrule (and thus the fiber) in place. The ferrule typically extends past the connector body to slip into a coupling device (such as an alignment sleeve) which is used to mate the connector to another connector or to a feed-through bulkhead adapter which is used to mate the connector to a fiber optic transmitter or receiver. The materials used to fabricate the ferrule, connector body, coupling device and/or bulkhead adapter must be capable of withstanding exposure to high temperatures in certain fiber optic end-use applications without significant distortion or warping, which would interfere with the ability to disconnect and reconnect the optic fiber cable or to maintain the required precise alignment and contact between the optic fiber ends that are being connected.

End-use applications where connectors are exposed to high temperatures and other harsh environmental conditions on an intermittent or essentially continuous basis also include, for example, under the hood applications in motor vehicles, aircraft engines, the engine compartments of heavy machinery and the like, chemical and oil processing operations and equipment, as well as subterranean well tools (downhole tools) and other devices and equipment used in oil and gas well operations.

Thus, the development of improved connectors having greater heat resistance would be highly desirable.

### BRIEF SUMMARY OF THE INVENTION

In one aspect of the invention, a connector (suitable, for example, for electrically connecting between an electric element and conductors on a surface of a printed circuit board or connecting optic fibers) is provided. The connector is comprised of an insulative main body that holds (directly or indirectly) one or more (e.g., an array of) conductive members, which may project from a surface of the electrically insulative main body. The main body is comprised of a polymeric composition comprising a polyetherketoneketone and mineral nanotubes. The conductive member may be capable of conducting electricity, transmitting light (e.g., pulses of light, capable of forming an electromagnetic carrier wave that is modulated to carry information), or conveying gases or liquids. The connector may, for example, be an electrical connector such as a single-pin connector, a multi-pin connector, a male connector, a female connector, a rotatable connector or a hermaphroditic connector or may be a fiber optic connector such as an FC connector, FDDI connector, LC connector, MT array connector, SC connector, SC duplex connector, ST connector or the like. The present invention may also be utilized for edge connectors, wire-to-board connectors, board-to-board connectors, electrical power connectors, electrical signal connectors, RF connectors, insulation displacement connectors and coaxial connectors.

In another aspect, the present invention provides a method of making a connector, such as an electrical connector useful for electrically connecting between an electric element and conductors on a surface of a circuit board. This method comprises providing one or more conductive members within a mold, said conductive members being held in a desired position and configuration, introducing a polymeric composition comprised of polyetherketoneketone and nanotubes into said mold (wherein the polymeric composition has been heated to a temperature effective to render it capable of flowing under pressure), filling said mold with the polymeric composition so as to encase at least a portion of the length of the conductive members while leaving the ends of the conductive members accessible, cooling said polymeric composition to a temperature effective to solidify said polymeric composition and to form the connector, and removing the connector from the mold.

Still another aspect of the invention provides an assembly comprising a circuit board and an electrical connector. The electrical connector comprises a electrically insulative main body that holds an array of electrically conductive contacts which may project from a surface of the main body, wherein said electrically conductive contacts are soldered to conductors on said circuit board and said electrically insulative main body is comprised of a polymeric composition comprising a polyetherketoneketone and mineral nanotubes.

A method of making an assembly is further provided by the present invention. This method is comprised of the following steps:
a) providing a circuit board having a plurality of conductors on a surface thereof;
b) providing an electrical connector comprising an electrically insulative main body that holds an array of electrically conductive contacts, which may project from a surface of the electrically insulative main body, and that is comprised of a polymeric composition comprising a polyetherketoneketone and mineral nanotubes;
c) bringing said electrical connector and said circuit board into alignment with each other such that each of the electrically conductive contacts are proximate to both a conductor on the surface of the circuit board and a portion of solid solder or solder paste to form an intermediate assembly;
d) heating said portions of solid solder or solder paste to a temperature effective to cause said portions of solid solder or solder paste to melt and flow (each melted solder portion thereby coining into intimate contact with both an electrically conductive contact and a conductor); and
e) cooling said intermediate assembly to a temperature effective to cause said portions of solder to re-solidify and establish electrically conductive connections between said electrically conductive contacts and said conductors.

The present invention additionally furnishes a method for separating an electrical connector from a circuit board wherein said electrical connector is attached to said circuit board through a set of interconnections comprised of solder, said method comprising heating said set of interconnections to a temperature effective to melt said solder and removing said electrical connector from said circuit board, wherein said electrical connector is comprised of an electrically insulative main body that holds an array of electrically conductive contacts and that is comprised of a polymeric composition comprising a polyetherketoneketone and mineral nanotubes.

The present invention also provides a method for attaching and removing an electrical connector from a circuit board and either re-attaching the same electrical connector or replacing the electrical connector with a second electrical connector. This method comprises:
a) providing a circuit board having a plurality of conductors on a surface thereof;
b) providing a first electrical connector comprising an electrically insulative main body that holds an array of electrically conductive contacts and that is comprised of a polymeric composition comprising a polyetherketoneketone and mineral nanotubes;
c) bringing said first electric connector and said circuit board into alignment with each other such that each of the electrically conductive contacts in said array are proximate to both a conductor on the surface of the circuit board and a portion of solid solder or solder paste to form an intermediate assembly;
d) heating said portions of solid solder or solder paste to a temperature effective to cause said portions of solid solder or solder paste to form portions of liquid solder capable of flowing;
e) cooling said portions of liquid solder to a temperature effective to cause said portions of liquid solder to solidify and establish electrically conductive connections between said electrically conductive contacts and said conductors;
f) heating said set of interconnections to a temperature effective to melt said solder;
g) removing said first electrical connector from said circuit board; and
h) repeating steps b)-e) using either said first electrical connector or a second electrical connector, said second electrical connector comprising an electrically insulative main body that holds an array of electrically conductive contacts and that is comprised of a polymeric composition comprising a polyetherketoneketone and mineral nanotubes.

Also provided by the invention is an assembly comprising a first optic fiber, an additional component selected from the group consisting of a second optic fiber, a fiber optic transmitter and a fiber optic receiver, and a connector which connects said first optic fiber and said additional component and which comprises an insulative main body that holds (directly or indirectly) one or more optic fibers, wherein said insulative main body is comprised of a polymeric composition comprising a polyetherketoneketone and mineral nanotubes.

In yet another aspect of the invention, an assembly is provided which comprises a first optic fiber, an additional component selected from the group consisting of a second optic fiber, a fiber optic transmitter and a fiber optic receiver, a connector which connects said first optic fiber and said additional component and which comprises an insulative main body that holds (directly or indirectly) one or more optic fibers, and a coupling device adapted to mate the first optic fiber to said additional component, wherein at least one of said insulative main body or said coupling device is comprised of a polymeric composition comprising a polyetherketoneketone and mineral nanotubes.

The present invention is particularly well suited for application in end uses where one or more conductive members that are part of a connector must be precisely aligned with other elements, both during initial assembly and following repeated exposure to heat. The heat distortion resistance of the main body, which is comprised of polyetherketoneketone and mineral nanotubes, allows the connector to be connected, disconnected, and reconnected while reproducibly maintaining the desired precise alignment of the conductive members, thereby ensuring that the conductive members remain capable of efficiently and effectively transmitting light, electricity or the like to the other element to which the connector is attached.

### DETAILED DESCRIPTION OF CERTAIN EMBODIMENTS OF THE INVENTION

The main body of a connector in accordance with the present invention is advantageously manufactured using a polymeric composition comprised of a polyetherketoneketone and mineral nanotubes. The use of this particular combination of components in the polymeric composition has been found to be critical to the attainment of a dimensionally stable connector capable of repeatedly withstanding elevated temperatures, such as the harsh conditions encountered during reflow soldering and reworking of a circuit board assembly, with minimal distortion, cracking and warping, particularly where the solder employed is a lead-free solder.

The heat resistance of the polymeric composition is surprisingly improved by the addition of the mineral nanotubes The mineral nanotubes offer the further advantage, as compared to other fillers, of being quite small in size, making it possible to fabricate connectors having smooth surfaces, even at relatively high loadings of the filler. Additionally, the mineral nanotubes favorably alter the melt flow behavior of the polyetherketoneketone, thereby facilitating the complete filling of molds having very fine features and permitting the molding of connectors having precise dimensions and shapes. Another benefit of the present invention is that exceptionally good adhesion between the polymeric composition and the surfaces of the conductive members is achieved, particularly where the conductive member surfaces are metallic. Superior resistance to failure at the polymeric composition/conductive member interface can thus be attained, which further helps to ensure continued good performance of the connector under prolonged harsh environmental conditions such as elevated temperatures and exposure to chemicals, solvents and the like. In addition, the use of polyetherketoneketone provides molded main bodies having lower residual stresses than are observed when other polyaryletherketones such as polyetheretherketone are employed. The lower amount of residual stress results in less warpage when the main body is exposed to high temperatures. Further, with polyetherketoneketone one can optimize the crystallinity and thereby the melting point (Tm) for the particular application, which cannot be done with polyetheretherketone.

The polyetherketoneketones suitable for use in the present invention contain (and preferably consist essentially of) repeating units represented by the following formulas I and II:

-A-C(═O)-B-C(═O)— I

-A- C(═O)-D-C(═O)— II

where A is a p,p′-Ph-O-Ph- group, Ph is a phenylene radical, B is p-phenylene, and D is m-phenylene. Although the Formula I : Formula II (T:I) isomer ratio in the polyetherketoneketone can range from 100:0 to 0:100, generally it will be desirable to employ a polyetherketoneketone having a T:I isomer ratio of about 70:30 or greater, preferably no greater than about 90:10. In one desirable embodiment, the polyetherketoneketone is semicrystalline.

Polyetherketoneketones are well-known in the art and can be prepared using any suitable polymerization technique, including the methods described in the following patents, each of which is incorporated herein by reference in its entirety for all purposes: U.S. Pat. Nos. 3,065,205; 3,441,538; 3,442,857; 3,516,966; 4,704,448; 4,816,556; and 6,177,518. Mixtures of polyetherketoneketones may be employed.

Suitable polyetherketoneketones are available from commercial sources, such as, for example, the polyetherketoneketones sold under the brand name OXPEKK by Oxford Performance Materials, Enfield, Conn., including OXPEKK-C polyetherketoneketone.

As mentioned previously, mineral nanotubes are a critical component of the polymeric composition utilized in the main body of the connectors of the present invention. As used herein, mineral nanotubes includes both inorganic materials and carbon nanotubes, that are cylindrical in form (i.e., having hollow tubular structures), with internal diameters typically ranging from about 10 to about 300 nm and lengths that typically are 10 to 10,000 times greater than the nanotube diameter (e.g., 500 nm to 1.2 microns). Generally, the aspect ratio (length to diameter) of the nanotubes will be relatively large, e.g., about 10:1 to about 200:1. The tubes need not be completely closed, e.g., they may take the form of tightly wound scrolls with multiple wall layers.

The nanotubes may be composed of known inorganic elements as well as carbon, including, but not limited to tungsten disulifide, vanadium oxide, manganese oxide, copper, bismuth, and aluminumsilicates. In one embodiment, the nanotubes are those formed from at least one chemical element chosen from elements of groups IIIa, IVa and Va of the periodic table, including those made from carbon, boron, phosphorus and/or nitrogen, for instance from carbon nitride, boron nitride, boron carbide, boron phosphide, phosphorus nitride and carbon nitride boride. Useful aluminumsilieates include imogolite, cylindrite, halloysite and boulangerite nanotubes as well as synthetically prepared aluminosilicate nanotubes. The surfaces of the nanotubes may be treated or modified as may be desired to alter their properties. Nanotubes may be refined, purified or otherwise treated (e.g., surface-treated and/or combined with other substances such that the other substances are retained within the nanotubes) prior to being combined with the polyetherketoneketone.

The amount of mineral nanotubes compounded with the polyetherketoneketone may be varied as desired, but generally the polymeric composition will comprise at least 0.01 weight percent, but no more than 30 weight percent, mineral nanotubes. For example, the polymeric composition may advantageously comprise from about 5 to about 20 weight percent halloysite. The polymeric composition may additionally be comprised of components other than the polyetherketoneketone and mineral nanotubes, such as stabilizers, pigments, processing aids, additional fillers, and the like. In certain embodiments of the invention, the polymeric composition consists essentially of or consists of polyetherketoneketone and mineral nanotubes. For example, the polymeric composition may be free or essentially free of any type of polymer other than polyetherketoneketone and/or free or essentially free of any type of filler other than mineral nanotubes.

The polymeric composition may be prepared using any suitable method, such as, for example, melt compounding the polyetherketoneketone and mineral nanotubes under conditions effective to intimately mix these components.

The polymeric composition may be shaped into the form desired for the main body of the connector using any suitable molding method, such as injection molding, insert molding, overmolding and the like. Preferably, the main body is molded as a unitary part, as the presence of seams may adversely affect the performance of the connector under high temperature conditions. For example, the polymeric composition may be heated to a temperature effective to soften or melt the polyetherketoneketone and render the polymeric composition capable of flowing and then introduced into a mold having the desired shape of the main body of the connector. Pressure may be applied so as to force the softened polymeric composition into the mold, thereby facilitating complete filling of the mold. The mold is provided with one or more conductive members, where the conductive members are held in a desired position and configuration. The mold may be a unitary mold or a mold comprised of two or more parts that are held together during the molding process. Typically, the mold is comprised of metal and during molding is held at a elevated temperature that is somewhat lower than the temperature of the polymeric composition being introduced into the mold, in order to promote complete filling of the mold and a molded main body of good quality. The mold may be filled with the polymeric composition so as to encase (encapsulate) a portion of the individual conductive members such that the ends of the conductive members are still accessible (exposed). For example, where an electrical connector is desired, one end of a conductive member may take the form of a pin projecting from a surface of the main body, with the pin being straight, bent, curved, angled or any other suitable configuration. The pins may take any desired or suitable cross-sectional shape such as round, oval, triangular, square, rectangular or the like and may have surfaces that are smooth, flat, grooved, ridged, threaded or some other form as may be desired or necessary depending upon the design of the conductors on the circuit board that the pins will be attached to through a solder interconnect. The other end of the conductive member may take the form of a recess (i.e., an opening or female receptable) capable of receiving a pin or the like, where the tip of the conductive member can be flush with a surface of the main body (although alternatively the conductive member tip could be recessed somewhat from the main body surface or even protrude out from the main body surface to some extent). Alternatively, both ends of a conductive member may be in the form of pins. In yet another embodiment, both ends may be in the form of recesses. The molded polymeric composition is then cooled to a temperature effective to solidify the softened polyetherketoneketone. The connector which is thereby formed can thereafter be removed from the mold. Alternatively, the main body can be formed by injection molding and the conductive members introduced thereafter (for example, the mold may be configured so as to provide openings in the main body into which or through which the conductive members may be inserted or otherwise introduced or the main body may be molded as a solid shape and openings for the conductive members thereafter formed by machining or drilling or the like).

The main body may be of any desired configuration, including but not limited to, those configurations known and developed in the art for use as electrical connectors and fiber optic connectors. The present invention is particularly suitable for use in manufacturing connectors having main bodies that are relatively thin and/or narrow in cross-section or that have features or sections that are relatively thin and/or narrow in cross-section (for example, where the main body contains one or more sections or portions that are relatively thick and wide as well as one or more sections or portions that are relatively thin or narrow), as such shapes will ordinarily be particularly susceptible to warping or distortion when the connector is subjected to high temperature conditions. Additionally, the molding of such shapes is facilitated by the use of the polymeric compositions of the present invention, as the introduction of the mineral nanotubes improves the flow behavior of the polyetherketoneketone.

In a fiber optic connector, the polymeric composition may be utilized in one or more different components making up the main body. For example, the main body may comprise both a connector housing and a ferrule, with the ferrule holding and surrounding an optic fiber and the connector housing in turn holding and surrounding the ferrule. One or both of the connector housing and the ferrule may be manufactured using a polymeric composition comprising polyetherketoneketone and mineral nanotubes in accordance with the present invention.

The conductive members may be made of any conductive materials known in the art, depending the type of connection that is desired. For example, where the connector is to be used as an electrical connector, the conductive member may be comprised of a metal or metal alloy, including metals and metal alloys such as nickel alloys, steel alloys, copper alloys, chromium nickel alloys, aluminum alloys, and silver alloys. An electrically conductive member may consist of one such material or may contain more than one such material. For instance, a conductive member may consist of a first electrically conductive material and may be plated or coated (over a portion or portions of its surface or its entire surface) with one or more different electrically conductive materials. Where the connector is to be used as a fiber optic connector, the conductive member may be comprised of glass, plastic or other material suitable for transmitting light. An optical fiber generally consists of a glass or plastic core, a glass or plastic cladding having a lower refractive index than the core, and a buffer (a protective outer coating, such as an acrylate), in which the cladding guides the light along the core by using the method of total internal reflection. Single-mode as well as multi-mode optical fibers may be employed as the conductive member. Where the conductive member is to be used to transmit or convey a gas or liquid, typically the conductive member will be in the form of a hollow tube or pipe, which may be constructed of any suitable material such as plastic or metal. Generally speaking, the conductive members are elongate in shape (i.e., having a length which is typically at least several times greater than the diameter of the conductive member) and are sufficiently long to extend at least from a first surface of the main body to a second surface of the main body (i.e., the conductive members penetrate through the main body). As mentioned previously, one end or both ends of each conductive member may project out from the main body surface to form a pin. In one embodiment, each conductive member is unitary but in other embodiment an individual conductive member may be comprised of two or more parts or sections that interconnect. The first surface and the second surface may be parallel to each other, perpendicular to each other, or have some other configuration relative to each other, as may be desired depending upon the particular application intended for the connector. Accordingly, the conductive members may be straight, bent, angled, curved or have any other appropriate shape and may be rigid or flexible. The number of conductive members per main body can be varied as desired.

In addition to the main body, one or more other components of the connector may be fabricated using the aforedescribed polymeric composition comprised of polyetherketoneketone and mineral nanotubes, especially where such other components will be similarly exposed to high temperatures and it is desired to maintain dimensional stability of these components under such conditions. For example, a coupling device or alignment sleeve or feed-through bulkhead adapter to be used in combination with a main body holding an optic fiber (e.g., a connector body) in order to mate the connector body to another connector body or to a fiber optic transmitter or receiver may be shaped to the desired form and dimensions by a molding technique such as injection molding using the polymeric composition.

### EXAMPLES

### Example 1

Non-conductive connectors for electrical applications: 1000 g of polyetherketoneketone (OXPEKK C from Oxford Performance materials) and from 10 to 200 g of non-conductive mineral nanotubes, or 5 to about 10 g of carbon nanotubes are blended using a twin screw Killion 27 mm counter-rotating extruder operating at temperatures of 365° C. (feed end) to 375° C. at the die to produce ⅛″ strands that are cooled in a water bath and chopped into ⅛″ by ¼″ pellets. After drying, for 6-8 hr at c.a. 120° C., the pellets are fed to a 28 or 40 ton Arburg injection molder fitted with a mold suitable for producing an electrical connector. The barrel and screw of the molder are heated at 318° C. (rear) to 327° C. at the nozzle while the mold is kept between 150 and 175° C. A conductive member would be placed in a mold in the desired position and configuration and the PEKK/mineral composition in a flowable melt would be introduced into the mold with a pressure of between 15,000 and 20,000 psi., sufficient to fill the mold with the polymeric composition so as to encase at least a portion of the length of the conductive members, while leaving the ends of the conductive members accessible. The molded connector is then cooled to a temperature effective to solidify the PEKK/nanotube composition to form a connector. The connector is then removed from the mold.

The content of the mineral nanotubes is adjusted within the ranges shown so as to provide a melt that completely fills the desired mold and yet provides optimum stiffness in the finished part. Higher loadings will provide stiffer parts but also stiffer melts that may not properly fill a mold with thin sections.

### Example 2

Electrodisipative connectors for nonelectrical applications: 1000 g OXPEKK C and from 20 to about 30 or 40 g of carbon nanotubes are blended and molded as in Example 1, using a mold suitable for the application. Said mold would not have inserted conductive members but would be capable of providing an electrical dissipative connection to a cable jacket, or other parts of the connector and on to a grounding device. Conditions of both the melt blending of the carbon nanotube and the PEKK and the injection molding are similar to Example 1.

1. A connector, comprising an insulative main body that holds one or more conductive members and that is comprised of a polymeric composition comprising a poiyetherketoneketone and mineral nanotubes.

2. The connector of claim 1, wherein said one or more conductive members are optic fibers.

3. The connector of claim 1, wherein said one or more conductive members are electrically conductive members.

4. The connector of claim 1, wherein said one or more conductive members are comprised of electrically conductive metal.

5. The connector of claim 1, wherein said one or more conductive members are in the form of hollow tubes capable of conveying a gas or liquid.

6. The connector of claim 1, wherein said insulative main body holds an array of electrically conductive members.

7. The connector of claim 1, wherein said mineral nanotubes are selected from elements of groups IIIa, IVa and Va of the periodic table.

8. The connector of claim 1, wherein said polymeric composition is comprised of 0.01 to 30 weight percent mineral nanotubes.

9. The connector of claim 1, wherein said polymeric composition is comprised of 5 to 20 weight percent mineral nanotubes.

10. The connector of claim 1, wherein the polyetherketoneketone is semi-crystalline.

11. The connector of claim 1, wherein the polyetherketoneketone is comprised of repeating units represented by formulas I and II:
-A-C(═O)-B-C(═O)— I
-A- C(═O)-D-C(═O)— II
wherein A is a p,p′-Ph-O-Ph- group, Ph is a phenylene radical, B is p-phenylene, and D is m-phenylene and the isomer ratio of formula I:formula II (T:I) ranges 70:30 to 90:10.

12. The connector of claim 1, wherein at least a portion of said conductive members are electrically conductive members having ends which project from a surface of said main body.

13. The connector of claim 1, wherein the connector contains one or more electrically conductive members penetrating the main body and wherein each of the electrically conductive members has at one end a connecting portion for connecting to an electric element and at the other end a terminal portion for connecting to a conductor.

14. The connector of claim 13 wherein the terminal portions are in the form of pins.

15. The connector of claim 13 wherein the connecting portions are recesses capable of receiving pins.

16. A method of making the connector of claim 1, said method comprising providing one or more conductive members within a mold, said conductive members being held in a desired position and configuration, introducing a flowable heated polymeric composition comprised of polyetherketoneketone and mineral nanotubes into said mold, filling said mold with the polymeric composition so as to encase at least a portion of the length of the conductive members while leaving the ends of the conductive members accessible, cooling said polymeric composition to a temperature effective to solidify said polymeric composition and to form the connector, and removing the connector from the mold.

17. An assembly comprising a circuit board and the connector of claim 1, comprising an electrically insulative main body that holds an array of electrically conductive contacts, wherein said electrically conductive contacts are soldered to conductors on said printed circuit board and said electrically insulative main body is comprised of a polymeric composition comprising a polyetherketoneketone and mineral nanotubes.

18. The assembly of claim 17, wherein said conductors are in the form of recesses in the printed circuit board and said electrically conductive contacts are inserted into said recesses.

19. The assembly of claim 17, wherein said solid solder or solder paste is lead- free.
